(19) United States
(12) Patent Application Publication
(10) Pub. No.: US 2002/0137863 A1
(43) Pub. Date: Sep. 26, 2002

(54) Cycloolefin copolymers and a process for their preparation

(75) Inventors: Frank Osan, Kelkheim (DE); Jurgen Kulpe, Frankfurt (DE); Willi Kreuder, Mainz (DE)

Correspondence Address: FROMMER LAWRENCE & HAUG, LLP, 10TH FLOOR, 745 FIFTH AVENUE, NEW YORK, NY, 10151, US

(73) Assignee: Hoechst Aktiengcsellschaft.

(21) Appl. No.: 10/113,720

(22) Filed: Apr. 1, 2002

Related U.S. Application Data
(63) Continuation of application No. 08/912,321, filed on Aug. 18, 1997, now abandoned.
Application No. 08/912,321 is a continuation of application No. 08/505,495, filed on Jul. 21, 1995, now abandoned.

(30) Foreign Application Priority Data
Jul. 26, 1994 (DE) P 44 26 398.8

(51) Int. Cl. C08F 4/44

(52) U.S. Cl. 526/160; 526/308; 526/182

(57) ABSTRACT

The present invention relates to cycloolefin copolymer having a solution viscosity (eta)>0.25 dl/g (measured in accordance with DIN 53 728 in decalin at 135° C.), comprising polymerized units (A) of at least one cyclic olefin and (B) if desired, one or more acyclic olefins, wherein (C) polymerized units are included which comprise at least one functionalized structural unit which

a) is derived from a cyclic olefin and contains at least one heteroatom attached directly to a ring atom of the cyclic olefin, or

b) is derived from a cyclic or acyclic olefin and contains at least one group of atoms containing two heteroatoms both attached to the same carbon atom, or

c) is derived from a cyclic or acyclic olefin and contains at least one aldehyde group, or

d) is derived from a cyclic or acyclic olefin and contains at least one group of atoms in which a nitrogen atom is attached via a double bond to a carbon atom,

and where, in the case that the functionalized structural unit is derived from a cyclic olefin, exactly two mutually adjacent carbon atoms of this functionalized cyclic structural unit are incorporated into the principal polymer chain. The cycloolefin copolymer is suitable for use as a coating material or adhesion promoter.

The invention relates to functionalized cycloolefin copolymers (COC) having a solution viscosity (eta)>0.25 dl/g which are suitable for producing highly mar-resistant coating materials, for example paints and varnishes, or as adhesion promoters, for example in coating compositions comprising one- or two-component binders. The invention also relates to a process for preparing COCs which are functionalized in this way.

In the automobile industry, bodywork topcoats and clearcoats exercise not only the conventional function of preventing corrosion and being decorative but also have a central role to play in respect of resistance to environmental effects. As the external coat it is necessary for the clearcoat, for example, to be resistant to light, acidic components and chemicals, such as grit, oil black, fuels and cleaning agents, but also to mechanical stress (e.g. in automatic washing units). Further requirements are good gloss retention, chalking resistance and constancy of color. In addition to this the individual coats of paint must be made so compatible with one another that individual components do not become detached, which would impair the function of the overall coating system. In this context the substrate to be coated is also significant. The coating material must display sufficient adhesion to the surface of the workpiece.

In recent years new topcoats and/or clearcoats have been developed with particular regard to environmental concerns. Particular mention may be made here of high solids and waterborne coating materials, whose low or zero content of organic solvents ensures relatively low polluting emissions in the course of processing (Organic Coatings, Science and Technology, 8 (1986), G. D. Parfitt,

A. V. Patsis (eds.)). Apart from alkyd-melamine resin coating materials, thermosetting acrylic resins are used in particular in this context. The outstanding performance of these systems in respect, for example, of processibility, gloss retention and color fastness is countered by low resistance to hydrolysis and a degree of surface hardness which is not satisfactory in every respect. Moreover, the adhesion properties of the coating systems show a highly sensitive dependence on the substrate to be coated. In most instances, appropriate pretreatment of the substrate surface is necessary.

The development of novel coating systems with substrate-specific properties continues to be of great importance.

EP 283 164 discloses that the copolymerization of α-olefins with cyclic polyenes and, if desired, cycloolefins enables the provision of COCs which contain double bonds, the cyclic polyenes used being, for example, nonconjugated dienes or trienes comprising norbornene as structural element. From JP 05279412-A it is known that hydroxyl and/or epoxy groups can be introduced into such double bond-containing COCs by epoxidation, with the resulting functionalized COCs being used as compatibilizers for olefinic polymer blends.

JP 2269760-A, JP 3072558-A and JP 3106962-A disclose polycyclic monomers which comprise carboxyl groups and are reacted by metathesis polymerization to give homopolymers and copolymers. The disadvantage of such a ring-opening polymerization, however, is that the polymer obtained first of all contains double bonds, which may lead to uncontrolled and unwanted interchain crosslinking and therefore may severely limit the capacity for the material to be processed by extrusion or injection molding.

EP-A-203 799 discloses COCs onto which α,β-unsaturated carboxylic acids such as acrylic acid are grafted in a polymer-analogous reaction. Furthermore, EP-A-570126 gives a description of the fact that COCs containing double bonds are grafted with monomers which are suitable for free-radical polymerization, for example styrene, vinyl chloride, acrylonitrile or vinyl acetate. However, the disadvantage of these polymer-analogous grafting reactions is that the resulting products lack uniformity with regard to the grafting yield, the grafting sites and the chain length of the graft branches. Moreover, the actual grafting reaction is often accompanied by homopolymerization of the monomer employed. In most cases it is then impossible to separate homopolymer and graft product. The reaction products obtained therefore have a very broad molecular weight distribution and are also chemically nonuniform. For the development of coating materials with a high solids content (high solids coating materials), however, products having as narrow a molecular weight distribution as possible and a controllable number of functional groups are the objective.

The object was therefore to provide a polymer which is readily miscible with other substances, especially polymers, and which is suitable for the production of highly mar-, acid- and base-resistant coatings, for example automotive finishes, whose adhesion to the substrate surface is improved.

Surprisingly it has been found that this object can be achieved by the provision of specific functionalized COCs. The functionalized COCs according to the invention comprise polymerized units containing functional groups which are introduced by a polymer-analogous ozonolysis reaction followed by working up and, if desired, by specific follow-on reactions.

The invention therefore relates to a cycloolefin copolymer having a solution viscosity (eta)>0.25 dl/g (measured in accordance with DIN 53728 in decalin at 135° C.) and which comprises polymerized units (A) of at least one cyclic olefin and (B), if desired, of one or more acyclic olefins, wherein (C) polymerized units are included which comprise at least one functionalized structural unit which

a) is derived from a cyclic olefin and contains at least one heteroatom attached directly to a ring atom of the cyclic olefin, or

b) is derived from a cyclic or acyclic olefin and contains at least one group of atoms containing two heteroatoms both attached to the same carbon atom, or

c) is derived from a cyclic or acyclic olefin and contains at least one aldehyde group, or

d) is derived from a cyclic or acyclic olefin and contains at least one group of atoms in which a nitrogen atom is attached via a double bond to a carbon atom,

and where, in the case that the functionalized structural unit is derived from a cyclic olefin, exactly two mutually adjacent carbon atoms of this functionalized cyclic structural unit are incorporated into the principal polymer chain.

The groups of atoms in the functionalized structural units, according to b) and d), and the aldehyde group of the functionalized structural unit according to c), can be attached to the cyclic or acyclic olefin components directly or via a hydrocarbon group of 1 to 20 carbon atoms, preferably a C₁-C₁₀-alkylene group which may be substituted by alkyl or aryl.

The term heteroatom refers, with the exception of carbon and hydrogen, to all elements of the Periodic Table of the Elements, preferably to oxygen, sulfur, nitrogen, phosphorus and silicon and especially to oxygen, sulfur and nitrogen. In strict accordance with the IUPAC nomenclature, the term main polymer chain refers to the continuous main chain of the polymer, which may possess a substitution pattern (G. Odian: Principles of Polymerization, second edition, 1981, p. 12). Accordingly, polypropylene for example possesses a polyethylene main chain, with a hydrogen atom being substituted by a methyl group at every other carbon atom.

The cycloolefin copolymer according to the invention preferably comprises

0.1-99.89% by weight, based on the total mass of the cycloolefin copolymer, of polymerized units (A) of at least one cyclic olefin,

0-80% by weight, based on the total mass of the cycloolefin copolymer, of polymerized units (B) of at least one acyclic olefin, and

0.01-50% by weight, based on the total mass of the cycloolefin copolymer, of polymerized units (C) which contain at least one functionalized structural unit which

a) is derived from a cyclic olefin and contains at least one heteroatom attached directly to a ring atom of the cyclic olefin, or

b) is derived from a cyclic or acyclic olefin and contains at least one group of atoms containing two heteroatoms both attached to the same carbon atom, or

c) is derived from a cyclic or acyclic olefin and contains at least one aldehyde group, or

d) is derived from a cyclic or acyclic olefin and contains at least one group of atoms in which a nitrogen atom is attached via a double bond to a carbon atom,

and where, in the case that the functionalized structural unit is derived from a cyclic olefin, exactly two mutually adjacent carbon atoms of this functionalized cyclic structural unit are incorporated into the main polymer chain. The polymerized units (A) are derived preferably from cycloolefins of the formulae (I), (II), (Ill), (IV), (V), (VI) and (VII)

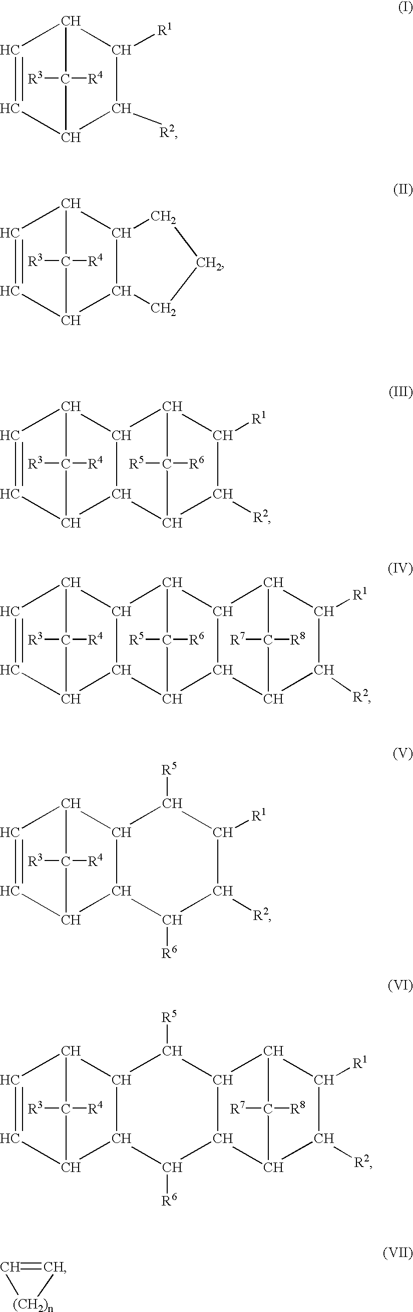

in which R¹, R2, R³, R⁴, R⁵, R⁶, R⁷ and R⁸ are identical or different and are a hydrogen atom or a C₁-C₃₀ hydrocarbon radical, such as a C₁-C₈-alkyl group or a C₆-C₁₄-aryl group, where identical radicals in the different formulae may have different meanings, and n is a number from 2 to 10.

The polymerized units (A) are with particular preference derived from norbornene.

The polymerized units (B) are derived preferably from acyclic monoolefins, for example α-olefins of 2 to 20 carbon atoms, especially ethylene and propylene.

The polymerized units (C) are derived preferably from compounds of the formulae (XIV), (XV), (XVI), (XVII), (XVIII) and (XIX)

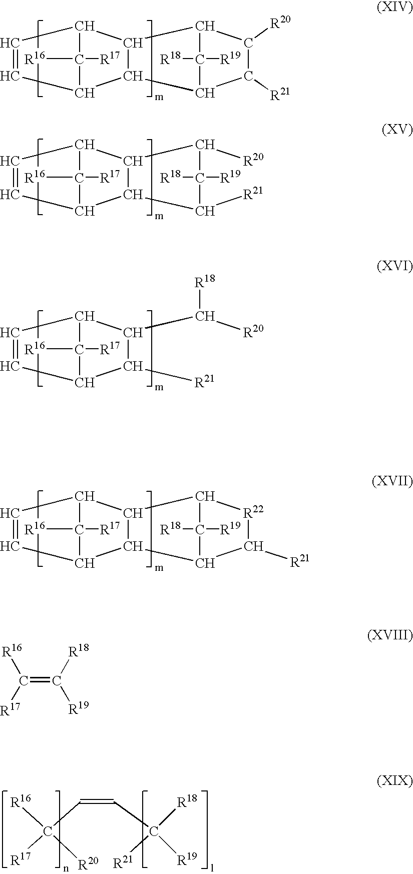

in which R¹⁶, R¹⁷, R¹⁸, R¹⁹, R²⁰ and R²¹ are identical or different, identical radicals in the different formulae may have different meanings, and are hydrogen, a C₁-C₃₀ hydrocarbon radical, such as a C₁-C₈-alkyl group or a C₆-C₁₄-aryl group, a primary, secondary or tertiary amino group, a substituted or unsubstituted ammonium group, a hydroxyl group, an alkyloxy group, an aryloxy group, an aralkyloxy group or a group —(X)ₚ—Y in which X is a branched or unbranched C₂-C₂₀-alkylene group or a branched or unbranched C₈-C₂₀-arylalkylene group and p=0 or 1 and Y is a carboxyl group, an alkyloxycarbonyl group, a carbamoyl group, a mono- or bisalkylcarbamoyl group, a chloroformyl group, an acyloxycarbonyl group, a thio-carboxy group, an alkylthiocarbonyl group, a formyl group, an alkylformyl group, a hydroxybis(alkyloxy)methyl group, a tris(alkyloxy)methyl group, a hydroxyiminomethyl group, a hydrazonomethyl group or a semicarbazonomethyl group, with the proviso that in the formulae (XIV) and (XVIII) at least one of the radicals R¹⁶, R¹⁷, R¹⁸, R¹⁹, R²⁰ or R²¹, in the formulae (XV), (XVI) and (XIX) at least two of the radicals R¹⁶, R¹⁷, R¹⁸, R¹⁹, R²⁰ or R²¹ and in formula (XVII) none of the radicals R¹⁶, R¹⁷, R¹⁸, R¹⁹, R²⁰ and R²¹ must be a group —(X)ₚ—Y, a primary, secondary or tertiary amino group, a substituted or unsubstituted ammonium group, a hydroxyl group, an alkyloxy group, an aryloxy group or an aralkyloxy group.

R²² is a carbonyl group, a hydroxyiminomethyl group, a hydrazonomethyl group or a semicarbazonomethyl group.

In the formulae (XV) and (XVI) p is 0 if R²⁰ or R²¹ is a group —(X)ₚ—Y. In formula (XIX) R²⁰ and R²¹ are not hydrogen or a C₁-C₃₀ hydrocarbon radical such as a C₁-C₈-alkyl group or a C₆-C₁₄-aryl group.

The polymerized units (C) are derived with particular preference from compounds of the formulae (XIV) to (XIX) in which R²² is a carbonyl group and R¹⁶, R¹⁷, R¹⁸, R¹⁹, R²⁰ and R²¹ are identical or different, identical radicals in the different formulae may have different meanings, and are a primary, secondary or tertiary amino group, a hydroxyl group or a group —(X)ₚ—Y in which X is a branched or unbranched C₂-C₂₀-alkylene group or a branched or unbranched C₈-C₂₀-arylalkylene group and p is 0 or 1 and Y is a carboxyl group or a formyl group, with the proviso that in the formulae (XIV) and (XVIII) at least one of the radicals R¹⁶, R¹⁷, R¹⁸, R¹⁹, R²⁰ or R²¹, in the formulae (XV), (XVI) and (XIX) at least two of the radicals R¹⁶, R¹⁷, R¹⁸, R¹⁹, R²⁰ or R²¹ and in formula (XVII) none of the radicals R¹⁶, R¹⁷, R¹⁸, R¹⁹, R²⁰ and R²¹ is or are a primary, secondary or tertiary amino group, a hydroxyl group or a group —(X)ₚ—Y in which X is a branched or unbranched C₂-C₂₀-alkylene group or a branched or unbranched C₈-C₂₀-arylalkylene group and p is 0 or 1 and Y is a carboxyl group or a formyl group.

The invention relates furthermore to a process for the preparation of a cycloolefin copolymer having a solution viscosity (eta)<0.25 dl/g, which comprises reacting a double bond-containing cycloolefin copolymer with ozone in an inert solvent.

To carry out the process according to the invention the COC containing double bonds is dissolved in an inert solvent. Inert solvents which may be employed are aliphatic hydrocarbons, for example decalin, halogenated aliphatic hydrocarbons, for example chloroform or carbon tetrachloride, or methanol or glacial acetic acid. Gassing with ozone is carried out in a suitable reaction vessel, for example a gassed stirred reactor or a bubble column. In this procedure a quantity of ozone which is equimolar with the double bond contents of the COC is passed into the solution. The ozone is produced using an ozone generator in dry air or oxygen. The concentration of ozone used in the carrier gas, air or oxygen, is not critical for the reaction procedure of the invention. It is typically from 1 to 180 g/m³, preferably from 10 to 50 g/m³. In practice it is chosen so that the uptake of ozone is as complete as possible. The uptake of ozone can be monitored by means of a suitable instrument, for example a UV photometer. In order to avoid a reduction in the molecular mass of the COC it is advantageous to carry out the gassing with ozone at a low temperature. This temperature is between −78 and +10° C., preferably between −10 and 0° C.

Owing to the tendency of the double bond-containing COCs used as starting materials to crosslink at relatively high temperatures, it may be advantageous to add an appropriate inhibitor which does not react chemically under the selected conditions. Suitable examples are phenothiazine and nitroaromatic compounds such as nitrobenzene and dinitrobenzene (U.S. Pat. No. 4,082,493).

After the end of ozonolysis a small quantity of alcohol, for example methanol, or water is added to the solution to avoid the formation of so-called ozonides.

Oxidative working up is carried out using peroxycarboxylic acids, for example those of formic, acetic or propionic acid. In this context it is possible to use the equilibrium per-acid or to prepare the per-acid in situ, by addition of carboxylic acid and a corresponding quantity of hydrogen peroxide, and also a catalytic quantity of mineral acid. The per-acid is employed in excess, the excess becoming smaller as the batch size rises. From 1 to 3, preferably from 1.1 to 1.8, molar equivalents of per-acid are employed per mole of double bond in the COC. In order to complete the oxidative working up, the solution is heated at reflux for a number of hours. The primary products of the oxidative working up are COCs containing carboxyl groups.

The reductive working up is carried out with reducing agents such as zinc dust in acetic acid or by means of catalytic hydrogenation with palladium on calcium carbonate or sodium dithionite. The reducing agent is employed in excess. From 1 to 4, preferably from 1.2 to 2.2, molar equivalents of reducing agent are employed per mole of double bond. In order to ensure complete reaction, the mixture is boiled at reflux for from 1 to 4 hours. This reductive working up leads primarily to COCs containing aldehyde and/or keto groups.

The polymer solution can be used further directly both after the oxidative and after the reductive working up. If the polymer is to be isolated as such, then it can be freed from the solvent by known methods:

1. stripping of the solvent, for example by steam distillation,

2. evaporating the solvent, for example by spray drying or thickening in a falling-film evaporator, which may be operated with a vacuum, and preferably by

3. precipitating the polymer in a nonsolvent which is miscible with the polymer solvent, for example methanol or acetone.

It is particularly preferred to isolate the functionalized COC by precipitation with acetone. In order to avoid the formation of cyclic peroxides of the acetone it must be ensured here that no more oxidizing agent is present in the solution; if necessary, remaining oxidizing agent must be removed by the appropriate addition of reducing agent.

By washing with solvents which do not dissolve the polymer it is easy to remove foreign substances such as by-products. Drying can be carried out at atmospheric pressure or reduced pressure, and also with inert gas blanketing, in which case the temperature employed must be below Tg in order to avoid sintering. Drying in a stream of nitrogen at mild temperatures is preferred.

All compounds obtained by oxidative or reductive working up may be subjected to follow-on reactions by means of which further functional groups are introduced into the COCs.

From the corresponding carboxylic acids it is possible by commonplace laboratory methods to prepare acid chlorides, esters, anhydrides, amides or hydrazides [J. March: Advanced Organic Chemistry, third edition].

The corresponding aldehydes and ketones may, for example, be reduced to alcohols. The reduction may take place catalytically over nickel or palladium or using nascent hydrogen which is produced in situ by reaction of sodium amalgam and water or sodium and alcohol. Particularly preferred reducing agents for preparing the corresponding alcohols are lithium aluminum hydride and sodium borohydride. Aluminum alcoholates, for example aluminum isopropylate, are also suitable. The reactions may optionally be catalyzed by addition of acids or bases. If the hydrogenation is carried out in the presence of ammonia or primary or secondary amines, then the corresponding primary, secondary or tertiary amines are obtained. For the preparation of these systems the amine component is employed in excess. In this context the preferred molar ratio of aldehyde to amine is 1:10, with particular preference being given to a ratio of 1.1:5.5. In the case of the direct addition of ammonia or primary or secondary amines with subsequent elimination of water, imines, azomethines, enamines or aminals are obtained [J. March: Advanced Organic Chemistry, third edition].

The derivatives obtained can be employed as crosslinking agents in powder coating systems or in other coating compositions. In this case it may be necessary to convert the amino groups of the COC derivative into isocyanate groups. Moreover, it is conceivable to employ these derivatives as polymer supports for immobilized catalysts, for example for fixation of enzymes, by way of hydroxyl and/or amino groups, for use in modern synthetic processes.

The addition of hydrocyanic acid to the aldehyde groups of the COC backbone is carried out with basic catalysis to form cyanohydrins (α-hydroxy nitrites), which can be reacted to α-hydroxy carboxylic acids. If the reaction is carried out in the presence of equimolar quantities of ammonia or primary or secondary amines, then the hydrocyanic acid adds onto the imino compounds which are formed initially. The resulting amino nitrites give α-amino acids when subsequently subjected to acid hydrolysis. By this method it is possible to achieve biocompatibility, which may be of particular advantage, especially for the use of these materials in the medical sector, for example as membranes.

In order to prepare acetals and hemiacetals the aldehyde- and/or ketone-functionalized COCs are reacted with the corresponding alcohols in the presence of anhydrous mineral acids. It is recommended to carry out the reaction in the presence of water-binding agents. Triethyl orthoformate may be used in particular for preparing the diethyl acetals of keto groups. Instead of the alcohols it is also possible to use thiols, which are reacted to give the corresponding mercaptans.

In addition to these, the aldehyde and/or ketone functionalities can be subjected to all known reactions. The formation of oximes, semicarbazones and hydrazones is mentioned only by way of example, these compounds being able to be prepared by the conventional methods from the corresponding COCs containing aldehyde and/or ketone groups. Mention may also be made of the possible variations given by aldol condensation [J. March: Advanced Organic Chemistry, third edition]. Moreover, the reactions described can also be configured as a crosslinking reaction. If the corresponding bifunctional compounds—for example diols, diamines, etc.—are employed, then a polymer network can be built up by intermolecular reaction. This gives rise to manifold possibilities for the subsequent crosslinking of a coating material comprising functionalized COCs.

The double bond-containing cycloolefin copolymers employed in the process according to the invention preferably comprise 0.1-99.89% by weight of polymerized units of a cycloolefin of the formula (I), (II), (III), (IV), (V), (VI) or (VII)

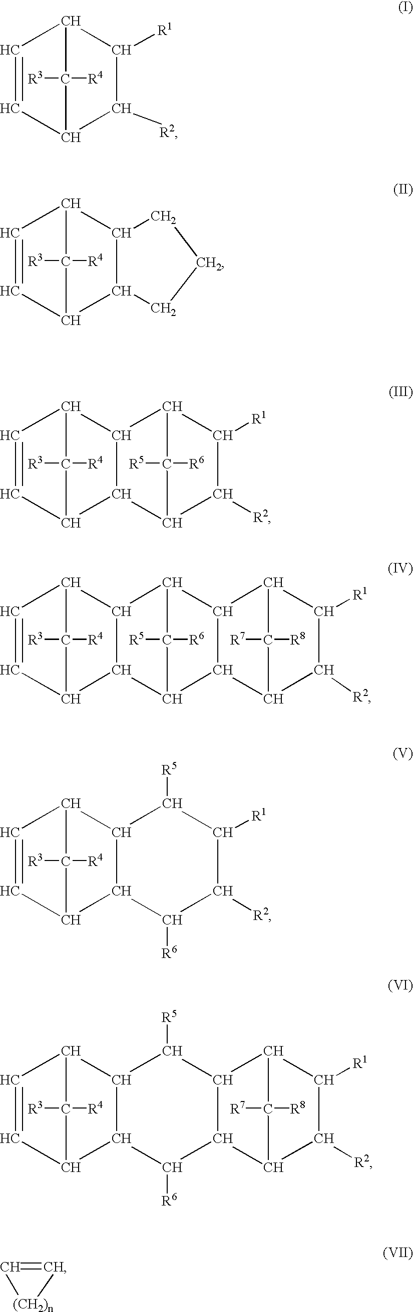

in which R¹, R², R³, R⁴, R⁵, R⁶, R⁷ and R⁸ are identical or different and are a hydrogen atom or a C₁-C₃₀ hydrocarbon radical, such as a C₁-C₈-alkyl group or a C₆-C₁₄-aryl group, where identical radicals in the different formulae may have different meanings, and n is a number from 2 to 10, and

0-80% by weight, based on the total mass of the cycloolefin polymer, of polymerized units of at least one acyclic monoolefin, preferably of an α-olefin of 2-20 carbon atoms, particularly preferably ethylene or propylene,

0.01-50% by weight, based on the total mass of the cycloolefin copolymer, of polymerized units of at least one olefin which comprise at least one double bond, preferably at least one olefin of the formulae (VIII), (IX), (X), (XI), (XII) and (XIII)

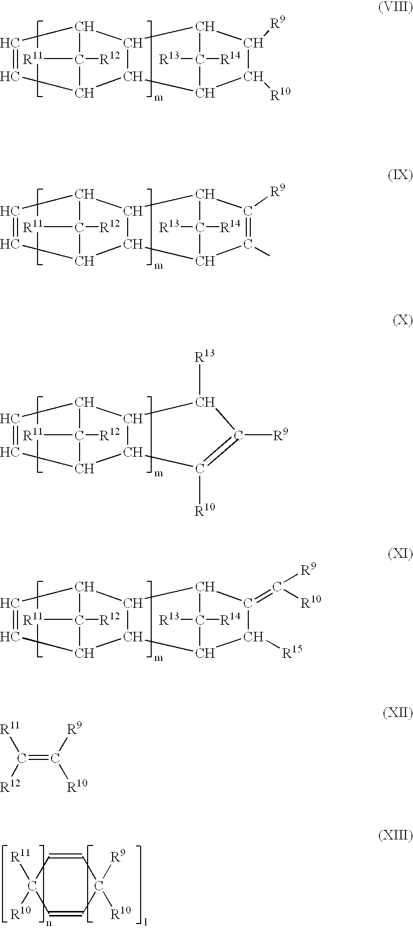

in which R⁹, R¹⁰, R¹¹, R¹², R¹³, R₁₄ and R¹⁵ are identical or different and are hydrogen atom, a C₁-C₃₀ hydrocarbon radical such as a C₁-C₈-alkyl group or a C₆-C₁₄-aryl group, a C₂-C₂₀-alkenyl group or a C8-C₂₀-arylalkenyl group, where identical radicals in the different formulae may have different meanings and, in the formulae (IX) and (X), R⁹ and R¹⁰ are a hydrogen atom or a C₁-C₃₀ hydrocarbon radical, such as a C₁-C₈-alkyl group or a C₆-C₁₄-aryl group, in the formula (VIII) at least one of the radicals R⁹, R¹⁰, R¹¹, R¹², R¹³ and R¹⁴ is an alkenyl group, in the formula (XII) at least one of the radicals R⁹, R¹⁰, R¹¹ and R¹² is an alkenyl group and m is a number from 0 to 10 and n and I are each numbers from 0 to 10, with the proviso that n=I=0 does not apply.

The double bond-containing cycloolefin copolymers employed in the process according to the invention may be prepared at temperatures of from −78°to 200° C. and at a pressure of from 0.01 to 64 bar in the presence of a catalyst system comprising at least one metallocene, which is preferably stereorigid, and at least one cocatalyst which is preferably an aluminoxane, in particular of the formula (XX)

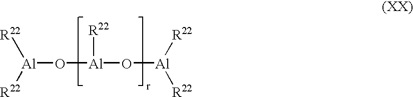

for the linear type and/or of the formula (XXI)

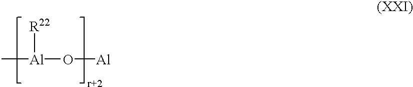

for the cyclic type, R²² in formulae (XX) and (XXI) being a C₁-C₂₀ hydrocarbon radical, for example a C₁-C₆-alkyl group, a C₆-C₁₄-aryl group, phenyl or benzyl, and r being an integer from 2 to 50.

Preference is given to stereorigid metallocenes, as described in P 43 44 631.0 to which reference is made expressly hereby.

Also preferred are metallocenes of the formula (XXII)

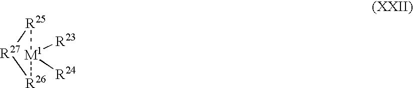

in which

M¹ is a metal from the group consisting of titanium, zirconium, hafnium, vanadium, niobium and tantalum, preferably zirconium or hafnium,

R²³ and R²⁴ are identical or different and are a hydrogen atom, a C₁-C₁₀-alkyl, preferably C₁-C₃-alkyl, group, a C₁-C₁₀-alkoxy, preferably C₁-C₃-alkoxy, group, a C₆-C₁₀-aryl, preferably C₆-C₈-aryl, group, a C₆-C₁₀-aryloxy, preferably C₆-C₈-aryloxy, group, a C₂-C₁₀-alkenyl, preferably C₂-C₄-alkenyl, group, a C₇-C₄₀-arylalkyl, preferably C₇-C₁₀-arylalkyl, group, a C₇-C₄₀-alkylaryl, preferably C₇-C₁₂-alkylaryl, group, a C₈-C₄₀-arylalkenyl, preferably C₈-C₁₂-arylalkenyl, group or a halogen atom, preferably chlorine,

R²⁵ and R²⁶ are identical or different and are a monocyclic or polycyclic hydrocarbon radical which is able to form a sandwich structure with the central atom M¹,

R²⁷ is a single- or multi-membered bridge which links to the radicals R²⁵ and R²⁶ and is

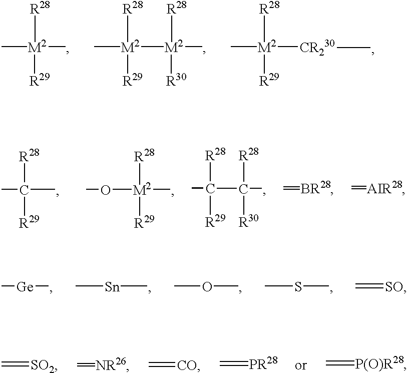

in which R²⁸, R²⁹ and R³⁰ are identical or different and are a hydrogen atom, a halogen atom, preferably chlorine, a C₁-C₁₀-alkyl, preferably C₁-C₃-alkyl, group, especially the methyl group, a C₁-C₁₀-fluoroalkyl group, preferably the CF₃ group, a C₆-C₁₀-fluoroaryl group, preferably the pentafluorophenyl group, a C₆-C₁₀-aryl, preferably C₆-C₈-aryl, group, a C₁-C₁₀-alkoxy, preferably C₁-C₄-alkoxy, group, especially the methoxy group, a C₂-C₁₀-alkenyl, preferably C₂-C₄-alkenyl, group, a C₇-C₄₀-arylalkyl, preferably C₇-C₁₀-arylalkyl, group, a C₈-C₄₀-arylalkenyl, preferably C₈-C₁₂-arylalkenyl, group, or a C₇-C₄₀-alkylaryl, preferably C₇-C₁₂-alkylaryl, group, or R²⁸ and R²⁹ or R²⁸ and R³⁰ form a ring, together with the atoms connecting them, and

M² is silicon, germanium or tin, preferably silicon or germanium.

Metallocenes of this kind are described in EP 0 407 870, to which reference is made expressly hereby.

In formula (XXII) M¹ is preferably zirconium or hafnium. R²³ and R²⁴ are identical or different and are preferably a C₁-C₁₀-alkyl group, in particular a methyl group, or a halogen atom, especially chlorine. R²⁵ and R²⁶ are identical or different and preferably cyclopentadienyl, 3-methylcyclopentadienyl, indenyl, tetrahydroindenyl, fluorenyl, 4,7-di-tert-butylfluorenyl or benzoindenyl. R²⁷ is preferably ═CR²⁸R²⁹, ═SiR²⁸R²⁹, ═GeR²⁸R²⁹,—O—, —S—, ═SO, PR²⁸ or ═P(O)R²⁸ in which R²⁸ and R²⁹ are a hydrogen atom, a C₁-C₁₀-alkyl group or a C₆-C₁₀-aryl group.

Particular preference is given to metallocenes such as (η⁵-cyclopentadienyl)dimethyl(η⁵-4,5,6,7-tetrahydroindenyl)ZrCl₂ or dimethylsilanediylbis(1 -indenyl)ZrCl₂.

In order to prepare the functionalized COCs according to the invention, use is made of double bond-containing COCs which have been prepared by ring-retaining polymerization; in other words, polymers obtained by metathesis polymerization are not employed here.

In the context of the process according to the invention it is advantageous that the functionalization of the double bond-containing COCs is possible without a reduction in the molecular mass of the polymer. The molecular weight distribution of the functionalized COCs which are accessible in this manner is therefore determined decisively by the polymer synthesis reaction. The functionalized COCs furthermore possess a well-defined number of functional groups, which can likewise be controlled within broad ranges by way of the quantities of monomer units which are employed in the polymerization reaction.

The functionalized COCs which are obtained by ozonolysis of double bond-containing COCs with oxidative and/or reductive working up are distinguished by outstanding adhesion to plastics, aluminum, steel and galvanized steel. For this reason the COCs according to the invention are particularly suitable as direct coating compositions for the production of acid- and mar-resistant protective coatings on the substrates mentioned. Such coating compositions comprise at least one cycloolefin copolymer according to the invention and, if desired, one or more binders, conventional paint additives, pigments and/or fillers.

Owing to their good compatibility and ability to be mixed homogenously with the coating compositions commonly used in paint technology, which comprise one-component or two-component binders, the COCs according to the invention are also suitable as adhesion promoters for the coating of plastics, for example, using these coating compositions. Following application to the workpiece to be coated it is possible to carry out curing with the appropriate crosslinking agents. The films produced in this way possess high transparency, heat deformation resistance and hardness and high surface gloss. Moreover, they are of improved acid resistance and greater mar resistance than the standard coatings.

The binders which may be used in this context are, for example, one-component or two-component polyurethane systems, epoxy resins, alkyd resins, melamine resins, saturated or unsaturated polyester resins, acrylate systems which can be crosslinked by means of irradiation or thermal treatment or by means of free-radical initiators, two-component OH-functional acrylate-polyurethane systems, thermoplastic polyacrylates such as polymethyl methacrylate, nitrocellulose, rubber grades or polyamide resins. It is also possible in principle to use binder mixtures containing more than one type of binder from those mentioned above. The one-component or two-component binders preferably employed are polyurethane systems or polyacrylate systems. Polyacrylate systems of this kind are described in the German Patent Applications which have not yet been published but have the file references P 43 44 515 and P 43 44 516, to which reference is made expressly hereby. When the functionalized COCs are employed as adhesion promoters, they are used in quantities of from 2 to 60% by weight, preferably from 15 to 40% by weight, based on the weight of the binder.

The coating compositions are preferably processed from solutions, examples of organic solvents which may be used being butyl acetate, methyl ethyl ketone, methyl isobutyl ketone, methoxypropyl acetate, toluene, xylene or mixtures of such solvents. Furthermore, the systems can also be employed in low-solvent or solventless coating compositions, especially aqueous coating compositions. In this context their use as adhesion promoters in powder coating applications is also conceivable. A good review of the possible coating compositions can be found in “Organic Coatings, Science and technology”, Volume 8 (1986).

The invention is illustrated in more detail by the examples which follow.

### EXAMPLE

### Definitions

eta=solution viscosity (in decalin at 135° C. in accordance with DIN 53728) in dl/g,

M_{w}=weight average molecular weight in g/mol,

M_{w}/Mₙ=polydispersity, measured by gel permeation chromatography (o-dichlorobenzene, 135° C., polystyrene standard),

equivalent weight (EW)=g of polymer/mol of functional group (determined titrimetrically)

IN=iodine number (g of iodine/100 g of polymer)

AN=acid number (mg of KOH/g of polymer)

Example 1 describes the preparation of the starting compound:

### Example 1

A clean and dry 1.5 dm³ polymerization reactor with stirrer was flushed with nitrogen and then with ethylene and filled with 0.6 dm³ of an 85% strength solution of norbornene in toluene. 60 ml of 5-vinyl-2-norbornene were added. The ethylene pressure was adjusted to 6 bar gauge. 180 cm³ of hydrogen were also added and the temperature was adjusted to 70° C. 12 mg of diphenylmethylene(cyclopentadienyl)(9-fluorenyl)zirconiumdichloride were dissolved in 20 cm³ of a solution of methylaluminoxane in toluene (10% by weight of methylaluminoxane of molecular mass 1300 g/mol by cryoscopic determination) and then the solution was metered into the reactor. By subsequent injection the ethylene pressure was maintained at 6 bar. After a polymerization time of one hour the reactor contents were run off into a vessel, and 5 cm³ of isopropanol were added. 10 g of ®Celite 545 (LuV, Hamburg) and 5 cm³ of water were added to the solution, which was stirred at 60° C. for 30 min. A filtercake consisting of 10 g of ®Celite suspended in 0.5 dm³ of toluene was built up on the filter mesh of a 2 I pressure suction filter. The polymer solution was filtered through the pressure suction filter, with a nitrogen pressure of about 1 bar being developed. The clear solution was introduced into 5 dm³ of acetone using a disperser (from Kotthoff). The solid was isolated by filtration, dispersed twice in acetone and then dried at 100° C. and under reduced pressure (0.2 bar) for 15 hours. 90 g of polymer were obtained, containing 50 mol % of repeating units of ethylene, 45 mol % of those of norbornene and 5 mol % of those of vinylnorbornene. The glass transition temperature was 151° C., eta was 0.15 dl/g (DIN 53728). M_{w}=9700 g/mol and M_{w}/Mₙ=2.2. An iodine number of 15.5 was found (EW=1640 g/mol of C=C).

Example 2 describes the preparation of a functionalized COC:

### Example 2

110 g (65 mmol) of the COC from Example 1 are dissolved in a mixture of 500 ml of chloroform and 50 ml of methanol. The solution is cooled to a temperature of −7 to −10° C. This temperature is also maintained during the gassing of ozone which follows. At a flow rate of 100 liters per hour and an ozone concentration of from 49 to 61 g of ozone per cubic meter of oxygen, a quantity of ozone which is equimolar with the double bond content of the COC is passed in. The ozone is produced using an ozone generator (model 503 from Fischer in Mekkenheim, Bonn, and an ozone meter, Ozontron 23, from the same manufacturer) in dry air or oxygen. After the end of gassing, a further 85 ml of methanol are added at −5° C. followed by 43 ml of peracetic acid at 0° C. The temperature is then raised slowly to 50° C. The reaction solution is stirred at this temperature for 2 hours. It is then cooled, washed with 200 ml of water and heated at reflux with 100 ml of water for one hour. The aqueous phase is separated off and the organic phase is washed with 100 ml of water. The carboxy-functionalized COC is isolated by precipitation with acetone followed by drying in vacua at mild temperatures.

Product weight: 80 g; iodine number: 15; acid number: 33.

Investigation of the adhesion properties of the functionalized COC prepared

10 g of the polymers from Examples 4-6 are in each case dissolved in 100 ml of toluene at 80° C. and the solutions are knife-coated onto glass plates, steel plates or polypropylene plates respectively. These plates are dried first of all at room temperature in a circulating-air drying oven for 4 h and then at 80° C. in a vacuum drying oven for 24 h.

In order to assess the adhesion of these films to the various substrates, the following qualitative tests are carried out:

a: Fingernail test: test for mechanical detachment of the film using the fingernail.

b: ®Tesa-Film test: test for mechanical detachment of the film by sharp removal of a strip of ®Tesa-Film which has been stuck on (scotch tape test).

c: Crosshatch test: the films are cut a number of times in crosswise formation using a sharp knife. The film is then tested for mechanical detachment by sharp removal of a strip of ®Tesa-Film which has been stuck onto the resulting lattice.

The results of these tests are compiled in Table 1. Also shown are the results for the unmodified COC.

TABLE 1
Investigating the adhesion properties of COC films

| | | | Fingernail | Scotch | |
|---|---|---|---|---|---|
| Example | COC | Substrate | test | tape | Crosshatch |
| 3 | COC II | Glass | ++ | ++ | ++ |
| 4 | COC II | Steel | ++ | ++ | ++ |
| 5 | COC II | PP | ++ | ++ | ++ |
| 6 | COC I | Glass | −− | −− | −− |
| 7 | COC I | Steel | −− | −− | −− |
| 8 | COC I | PP | −− | −− | −− |

Key:
The following abbreviations are used:
Polymer from Example 1 = COC I
Polymer from Example 2 = COC II
++ = very good adhesion. The films withstand the test method indicated without damage.
−− = very poor adhesion. The films are partly destroyed by the test methods indicated.

The propylene plate employed is a commercial EPDM-modified polypropylene plate from Hoechst AG measuring 200×50 mm.

1. A cycloolefin copolymer having a solution viscosity (eta)>0.25 dl/g (measured in accordance with DIN 53 728 in decalin at 135° C. ), comprising polymerized units (A) of at least one cyclic olefin and (B) if desired, one or more acyclic olefins, wherein (C) polymerized units are included which comprise at least one functionalized structural unit which
a) is derived from a cyclic olefin and contains at least one heteroatom attached directly to a ring atom of the cyclic olefin, or
b) is derived from a cyclic or acyclic olefin and contains at least one group of atoms containing two heteroatoms both attached to the same carbon atom, or
c) is derived from a cyclic or acyclic olefin and contains at least one aldehyde group, or
d) is derived from a cyclic or acyclic olefin and contains at least one group of atoms in which a nitrogen atom is attached via a double bond to a carbon atom,
and where, in the case that the functionalized structural unit is derived from a cyclic olefin, exactly two mutually adjacent carbon atoms of this functionalized cyclic structural unit are incorporated into the principal polymer chain.

2. A cycloolefin copolymer as claimed in claim 1, which comprises 0.1-99.89% by weight, based on the total mass of the cycloolefin copolymer, of polymerized units (A) of at least one cyclic olefin,
0-80% by weight, based on the total mass of the cycloolefin copolymer, of polymerized units (B) of at least one acyclic olefin, and
0.01-50% by weight, based on the total mass of the cycloolefin copolymer, of polymerized units (C) which contain at least one functionalized structural unit.

3. A cycloolefin copolymer as claimed in claim 1, wherein the polymerized units (A) are derived from at least one compound of the formulae (I), (II), (III), (IV), (V), (VI) or (VII) 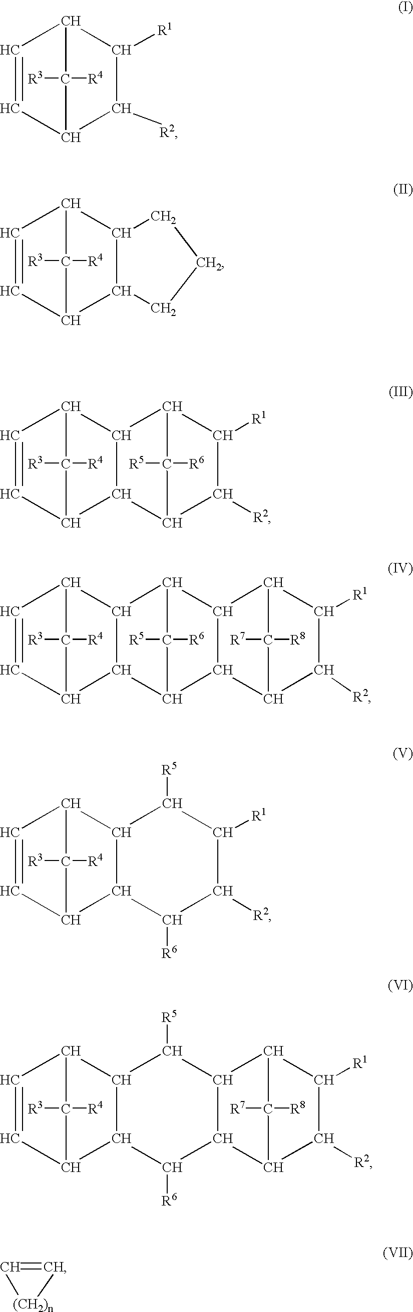
in which R¹, R², R³, R⁴, R⁵, R⁶, R⁷ and R⁸ are identical or different and are a hydrogen atom or a C₁-C₃₀ hydrocarbon radical, such as a C₁-C₈-alkyl group or a C₆-C₁₄-aryl group, where identical radicals in the different formulae may have different meanings, and n is a number from 2 to 10.

4. A cycloolefin copolymer as claimed in claim 1, wherein the polymerized units (B) are derived from an α-olefin of 2-20 carbon atoms.

5. A cycloolefin copolymer as claimed in claim 1, wherein the polymerized units (C) are derived from at least one compound of the formulae (XIV), (XV), (XVI), (XVII), (XVIII) or (XIX) 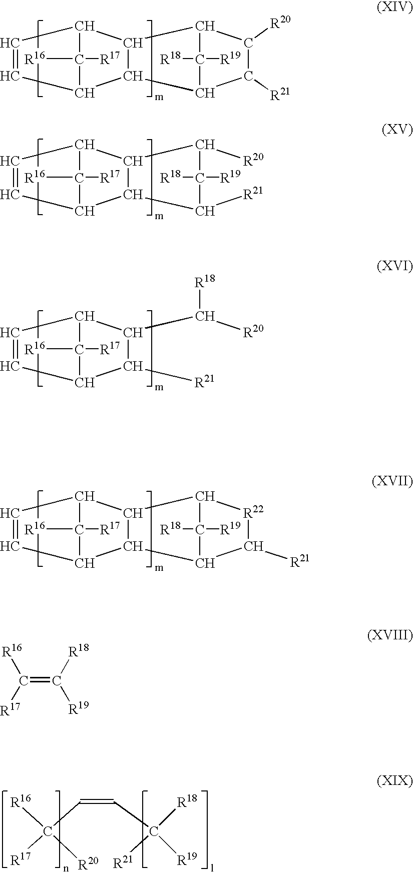
in which R²² is a carbonyl group, a hydroxyiminomethyl group, a hydrazonomethyl group or a semicarbazonomethyl group and R¹⁶, R¹⁷, R¹⁸, R¹⁹, R²⁰ and R²¹ are identical or different, identical radicals in the different formulae may have different meanings, and are hydrogen, a C₁-C₃₀ hydrocarbon radical, a primary, secondary or tertiary amino group, a substituted or unsubstituted ammonium group, a hydroxyl group, an alkyloxy group, an aryloxy group, an aralkyloxy group or a group —(X)ₚ—Y in which X is a branched or unbranched C₂-C₂₀-alkylene group or a branched or unbranched C₈-C₂₀-arylalkylene group and p=0 or 1 and Y is a carboxyl group, an alkyloxycarbonyl group, a carbamoyl group, a mono- or bisalkylcarbamoyl group, a chloroformyl group, an acyloxycarbonyl group, a thiocarboxy group, an alkylthiocarbonyl group, a formyl group, an alkylformyl group, a hydroxybis(alkyloxy)methyl group, a tris(alkyloxy)methyl group, a hydroxyiminomethyl group, a hydrazonomethyl group or a semicarbazonomethyl group, with the proviso that in the formulae (XIV) and (XVIII) at least one of the radicals R¹⁶, R¹⁷, R¹⁸, R¹⁹, R²⁰ or R²¹, in the formulae (XV), (XVI) and (XIX) at least two of the radicals R¹⁶, R¹⁷, R¹⁸, R¹⁹, R²⁰ or R²¹ and in formula (XVII) none of the radicals R¹⁶, R¹⁷, R¹⁸, R¹⁹, R²⁰ and R²¹ is or are a group —(X)ₚ—Y, a primary, secondary or tertiary amino group, a substituted or unsubstituted ammonium group, a hydroxyl group, an alkyloxy group, an aryloxy group or an aralkyloxy group, where in the formulae (XV) and (XVI) p is 0 if R²⁰ or R²¹ is a group —(X)ₚ—Y and in formula (XIX) R²⁰ and R²¹ are not hydrogen or a C₁-C₃₀ hydrocarbon radical.

6. A cycloolefin copolymer as claimed in claim 1, wherein the polymerized units (C) are derived from compounds of the formulae (XIV) to (XIX) in which R²² is a carbonyl group and R¹⁶, R¹⁷, R¹⁸, R¹⁹, R²⁰ and R²¹ are identical or different, identical radicals in the different formulae may have different meanings, and are a primary, secondary or tertiary amino group, a hydroxyl group or a group —(X)ₚ—Y in which X is a branched or unbranched C₂-C₂₀-alkylene group or a branched or unbranched C₈-C₂₀-arylalkylene group and p is 0 or 1 and Y is a carboxyl group or a formyl group, with the proviso that in the formulae (XIV) and (XVIII) at least one of the radicals R¹⁶, R ¹⁷, R¹⁸, R¹⁹, R²⁰ or R²¹, in the formulae (XV), (XVI) and (XIX) at least two of the radicals R¹⁶, R¹⁷, R¹⁸, R¹⁹, R²⁰ or R²¹ and in formula (XVII) none of the radicals R¹⁶, R¹⁷, R¹⁸, R¹⁹, R²⁰ and R²¹ is or are a primary, secondary or tertiary amino group, a hydroxyl group or a group —(X)ₚ—Y and in the formulae (XV) and (XVI) p is 0 if R²⁰ or R²¹ is a group —(X)ₚ—Y.

7. A process for the preparation of a cycloolefin copolymer having a solution viscosity (eta)>0.25 dl/g (measured in accordance with DIN 53728 in decalin at 135° C.) which comprises polymerized units (A) of at least one cyclic olefin and (B), if desired, of one or more acyclic olefins and (C) includes polymerized units which comprise at least one functionalized structural unit which
a) is derived from a cyclic olefin and contains at least one heteroatom attached directly to a ring atom of the cyclic olefin, or
b) is derived from a cyclic or acyclic olefin and contains at least one group of atoms containing two heteroatoms both attached to the same carbon atom, or
c) is derived from a cyclic or acyclic olefin and contains at least one aldehyde group, or
d) is derived from a cyclic or acyclic olefin and contains at least one group of atoms in which a nitrogen atom is attached via a double bond to a carbon atom,
and where, in the case that the functionalized structural unit is derived from a cyclic olefin, exactly two mutually adjacent carbon atoms of this functionalized cyclic structural unit are incorporated into the main polymer chain, which comprises reacting a cycloolefin copolymer containing double bonds with ozone in an inert solvent.

8. A process as claimed in claim 7, wherein the double bond-containing cycloolefin copolymer comprises
0.1-99.9% by weight of polymerized units of a cycloolefin of the formula (I), (II), (III), (IV), (V), (VI) or (VII) 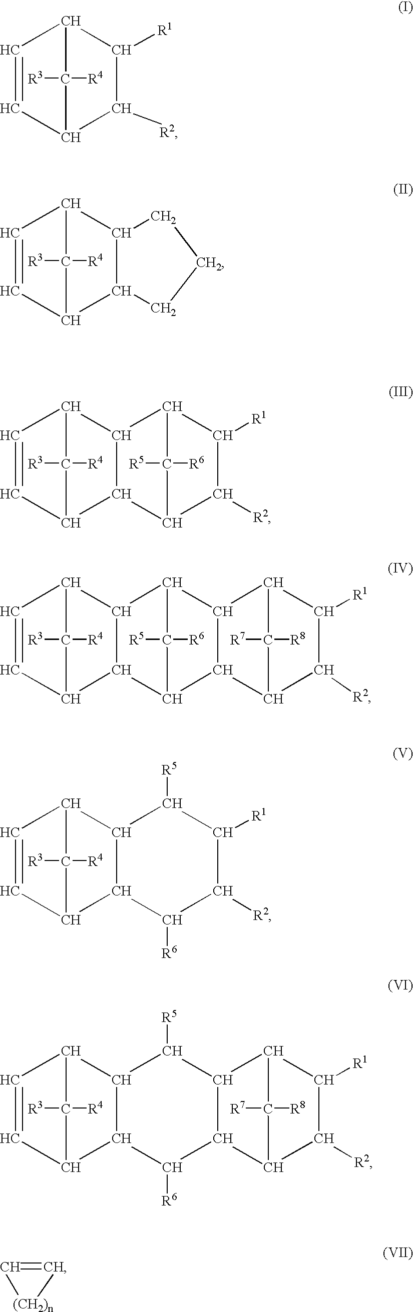
0-80% by weight, based on the total mass of the cycloolefin polymer, of polymerized units of at least one acyclic monoolefin, and
0.1-99.9% by weight, based on the total mass of the cycloolefin copolymer, of polymerized units of at least one olefin which comprise at least one double bond, preferably at least one olefin of the formulae (VII), (IX), (X), (XI), (XII) and (XIII).

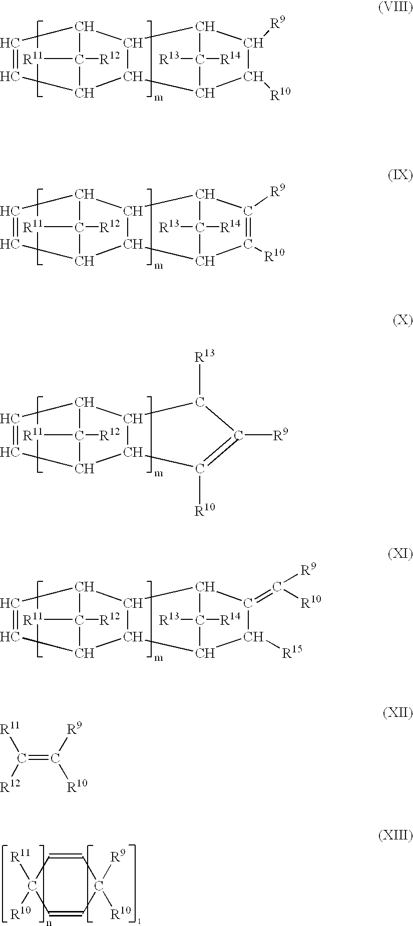

9. A coating material comprising at least one cycloolefin copolymer as claimed in claim 1 and, if desired, one or more binders, conventional paint additives, pigments and/or fillers.

10. An adhesion promoter comprising at least one cycloolefin copolymer as claimed in claim 1.
